(19) United States
(12) Patent Application Publication
(10) Pub. No.: US 2026/0238698 A1
(43) Pub. Date: Aug. 13, 2026

(54) NETWORK-INITIATED MULTI-PIN PDU SESSION MODIFICATION

(71) Applicant: InterDigital Patent Holdings, Inc., Wilmington, DE (US)

(72) Inventors: Anuj Sethi, Ottawa (CA); Michael Starsinic, Newtown, PA (US); Saad Ahmad, Montreal (CA); Debashish Purkayastha, Eagleville, PA (US); Taimoor Abbas, Sainte-Julie (CA)

(73) Assignee: InterDigital Patent Holdings, Inc., Wilmington, DE (US)

(21) Appl. No.: 19/150,017

(22) PCT Filed: Feb. 2, 2024
(86) PCT No.: PCT/US2024/014235

§ 371 Date: Jul. 22, 2025

Related U.S. Application Data
(60) Provisional application No. 63/444,313, filed on Feb. 9, 2023.

(51) Int. Cl. H04L 67/147; H04L 67/12

(52) U.S. Cl. CPC H04L 67/147; H04L 67/12

(57) ABSTRACT

A wireless transmit/receive unit (WTRU) may include one or more processors. The WTRU may establish a multi-personal internet of things (IoT) network (PIN) protocol data unit (PDU) session associated with sending and receiving data among an external network and a first PIN and a second PIN. The WTRU may receive a first non-access stratum (NAS) message from the external network. The first NAS message may include a deactivation indication associated with the second PIN. The WTRU may receive data from the second PIN in the multi-PIN PDU session. The WTRU may determine to block the data received from the second PIN in the multi-PIN PDU session based on the deactivation indication. The WTRU may send a second NAS message to the external network that indicates that the traffic from the second PIN will be blocked for the multi-PIN PDU session.

### CROSS REFERENCE TO RELATED APPLICATIONS

This application claims the benefit of U.S. Provisional Patent Application No. 63/444,313, filed Feb. 9, 2023, which is incorporated herein by reference in its entirety.

### BACKGROUND

A personal IoT network (PIN) may be a configured and managed group of PIN Elements that are able to communicate with each other directly or via PIN Elements with Gateway Capability (PEGC), communicate with the network via at least one PEGC, and are managed by at least one PIN Element with Management Capability (PEMC). A PIN element (PINE) may be a wireless transmit/receive unit (WTRU) and/or a non-3GPP device that can communicate within a PIN (e.g., via PIN direct connection, via PEGC, or via PEGC and the network), or outside the PIN via a PEGC and the network. The PIN Element with Gateway Capability (PEGC) may be a PIN Element with the ability to provide connectivity to and from the network for other PIN Elements, or to provide relay for the communication between PIN Elements. The PIN Element with Management Capability (PEMC) may be a PIN Element with capability to manage the PIN.

### SUMMARY

A network may initiate a multi-personal internet of things (IoT) network (PIN) protocol data unit (PDU) session modification. A wireless transmit/receive unit (WTRU) may include one or more processors. The WTRU may be configured to establish a multi-PIN PDU session associated with sending and receiving data among an external network and a first PIN and a second PIN. The WTRU may be configured to receive a first non-access stratum (NAS) message from the external network. The first NAS message may include a deactivation indication associated with the second PIN. The WTRU may be configured to receive data from the second PIN in the multi-PIN PDU session. The WTRU may be configured to determine to block the data received from the second PIN in the multi-PIN PDU session based on the deactivation indication. The WTRU may be configured to send a second NAS message to the external network that indicates that the traffic from the second PIN will be blocked for the multi-PIN PDU session. For example, the first NAS message may be a PDU session modification command message and the second NAS message may be a PDU session modification complete message.

The deactivation indication associated with the second PIN may include a PIN session status information element. The PIN session status information element may be configured to indicate whether a respective PIN is activated, partially deactivated, deactivated, or deleted. The PIN session status information element may include a minimal length of 4 octets and a maximum length of 34 octets.

The WTRU may be further configured to set an internal status for the second PIN to deactivated based on the PDU session modification message.

The deactivation indication associated with the second PIN may indicate that the second PIN is at least partially deactivated. The deactivation indication associated with the second PIN may include a deactivation indication only associated with the second PIN.

The WTRU may be configured to send a PDU session modification request message to the external network. The PDU session modification request message may include the deactivation indication associated with the second PIN. The PDU session modification command message may be received in response to the PDU session modification request message.

The first NAS message may be a policy command message that includes one or more of updated user equipment route selection policy (URSP) rules. The one or more of the updated URSP rules may include a traffic descriptor. The traffic descriptor may be associated with the second PIN. The traffic descriptor may include an indication to block traffic that matches the traffic descriptor.

The WTRU may be configured to receive data from the first PIN. The WTRU may be configured to determine to allow the data received from the first PIN to use an uplink/downlink (UL/DL) data traffic to the external network based on the first NAS message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram which illustrates an example personal internet of things (IoT) networks (PIN) architecture.

FIG. 3 is a diagram which illustrates an example of PIN in a home automation environment.

FIG. 4 is a diagram which illustrates an example of PIN in a wearable device environment.

FIG. 5 is a diagram which illustrates an example PIN Application Framework (PINAPP) architecture.

FIG. 6 is a diagram which illustrates an example network-initiated protocol data units (PDU) session modification.

FIG. 7 is a diagram which illustrates an example WTRU initiated PDU session modification.

FIG. 8 is a diagram which illustrates an example PDU session re-establishment.

FIG. 9 is a diagram which illustrates an example policy update at PIN deactivation/deletion.

### DETAILED DESCRIPTION

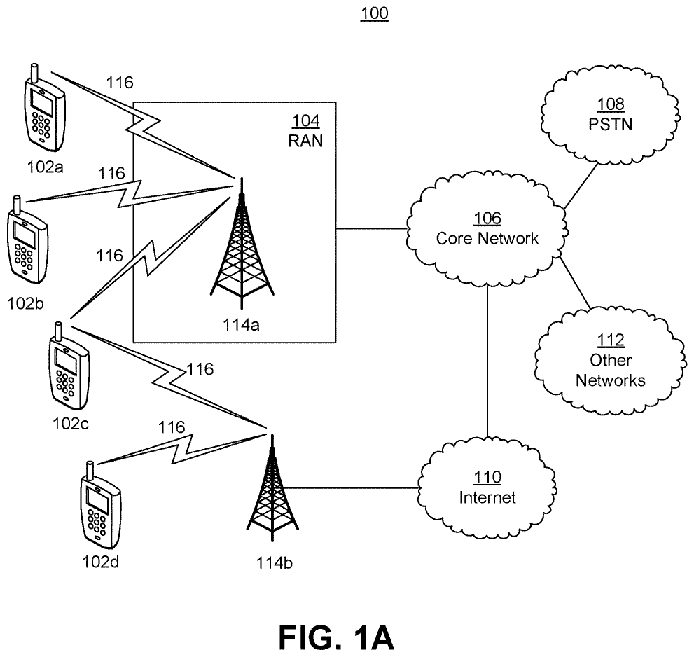

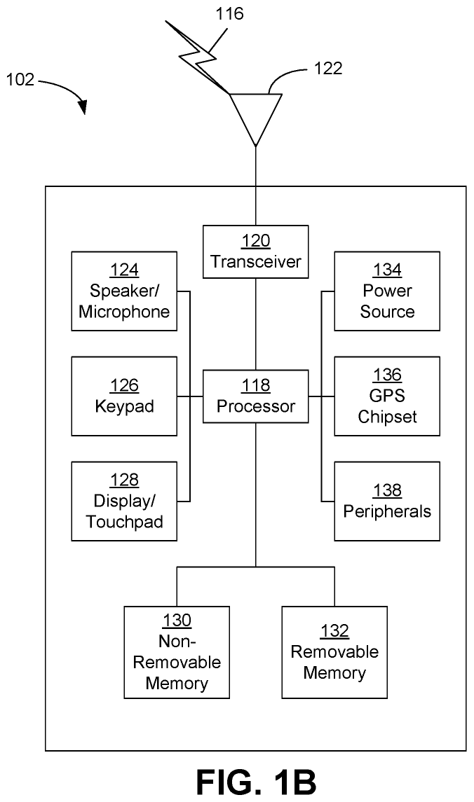

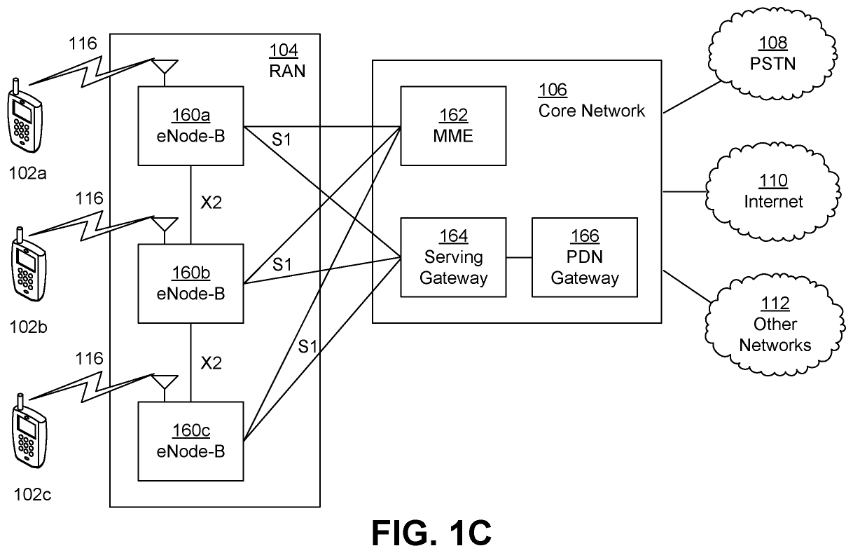

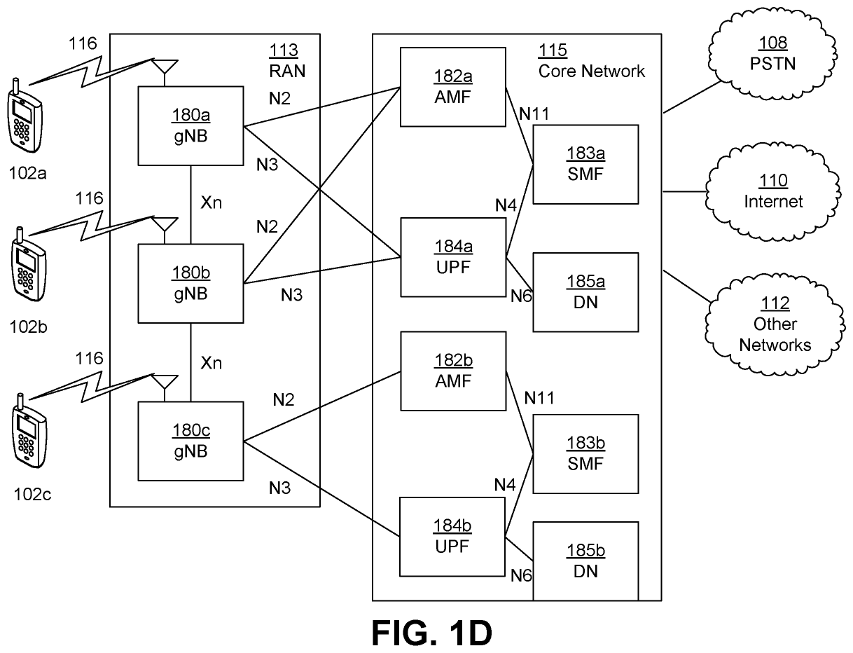

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A personal Internet of Things (IoT) network (PIN) may be a configured and managed group of PIN Elements. The configured and managed group of PIN Elements may communicate with each other directly or via PIN Elements with Gateway Capability (PEGC), communicate with the network via at least one PEGC, and managed by at least one PIN Element with Management Capability (PEMC). A PIN element (PINE) may be a WTRU and/or a non-3rd Generation Partnership Project (non-3GPP) device that can communicate within a PIN (via PIN direct connection, via PEGC, or via PEGC and the core network), or outside the PIN via a PEGC and the core network. The PEGC may be a PIN Element with the ability to provide connectivity to and from the network for other PIN Elements and/or to provide relay for the communication between PIN Elements. The PEMC may be a PIN Element with capability to manage the PIN.

PINE-to-PINE communication may include communication between two PINEs which uses a PINE-to-PINE direct connection or a PINE-to-PINE indirect connection. For example, a PINE-to-PINE direct connection may be a connection between two PIN Elements without a PEGC, a 3GPP radio access network (RAN), and/or a core network entity in the middle. A PINE-to-PINE indirect connection may be a connection between two PIN Elements via a PEGC and/or via user plane function (UPF).

In PINE-to-PINE routing, traffic may be routed by a PEGC between two PINEs. The two PINES may directly connect with the PEGC via non-3GPP access. In PINE-to-Network routing, traffic may be routed by a PEGC between the PINE and the network (e.g., 5G system (5GS)). The PINE may connect directly with the PEGC via non-3GPP access separately. In network local switch for PIN, traffic may be routed by UPF(s) between two PINEs. The two PINEs may directly connect with two PEGCs via non-3GPP access separately.

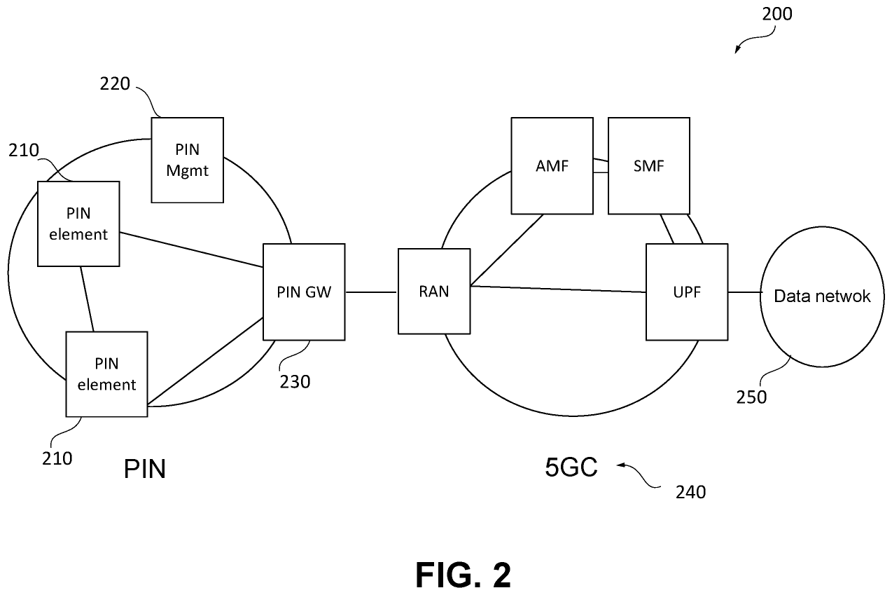

FIG. 2 shows an example PIN network architecture 200. A PIN may include one or more PIN Elements 210, a PIN Management device (PIN Mgmt) 220, and/or a PIN Gateway (PIN GW) 230. Each of the one or more PIN elements 210 may be a WTRU or any one of a number of different non-3GPP devices that have an ability to communicate within a PIN. The PIN management device 220 may be a PIN Element with capability to manage the PIN. A PIN GW 230 may be a PIN Element that has the ability to provide connectivity to and from the 5G network for one or more other PIN Elements.

The one or more PIN elements 210 may communicate with each other through a number of methods, such as through a PIN GW 230. The one or more PIN elements 210 may also communicate with each other directly. Additionally or alternatively, the one or more PIN elements 210 may communicate with the network (e.g., 5G system) to obtain network (e.g., 5G) services. The one or more PIN elements 210 may also communicate with a data network 250 via the 5G core network 240. The PIN Mgmt device 220 (e.g., PIN element with management capabilities) may be a WTRU. The PIN GW device 230 (e.g., PIN element with gateway capabilities) may be a WTRU. Communications within the PIN may be carried out using one or more of a number of non-3GPP communications such as WiFi, Bluetooth, and/or the like.

One or more of the following assumptions may apply to PINs. A 3rd Generation Partnership Project (3GPP) WTRU (e.g., only a 3GPP WTRU) may act as PEGC and/or PEMC. There may be one or more PEGCs in a PIN. There may be one or more PEMCs in a PIN, at any point of time one of which is able to control the PIN. The PIN Elements may assume to use non-3GPP access (e.g., WIFI, Bluetooth, etc.) for direct communication. The PEMC may use ProSe Direct Communication for direct communication with PEGC. The PEGC and PEMC may belong to the same public land mobile network (PLMN) or (standalone) non-public network (NPN). A single PEGC may support more than one PIN at a time.

The IoT feature may have been designed for devices that communicate using the traditional cellular network. Devices with IoT capabilities may require better power consuming performance and increase the network efficiency for bulk operations.

When multiple IoT devices are deployed in a private environment, the WTRUs with IoT capabilities may be organized in a PIN. For example, in the home environment, security sensor, smart light, smart plug, printer, cellphone, and the like, the devices may be managed by a residential gateway and communicate with each other. In this case, one or more (e.g., all) devices in the home may constitute a PIN. Each of the devices may be called a PIN element. Different PIN elements may have different capabilities. For example, a residential gateway may be a PEGC to provide connections between PIN elements and connections between the network and PIN Elements. A PEMC may be a PIN Element that provides a means for an authorized administrator to configure and manage a PIN. Residential gateway which acts as a PEGC may support PIN management function as well and be a PEMC.

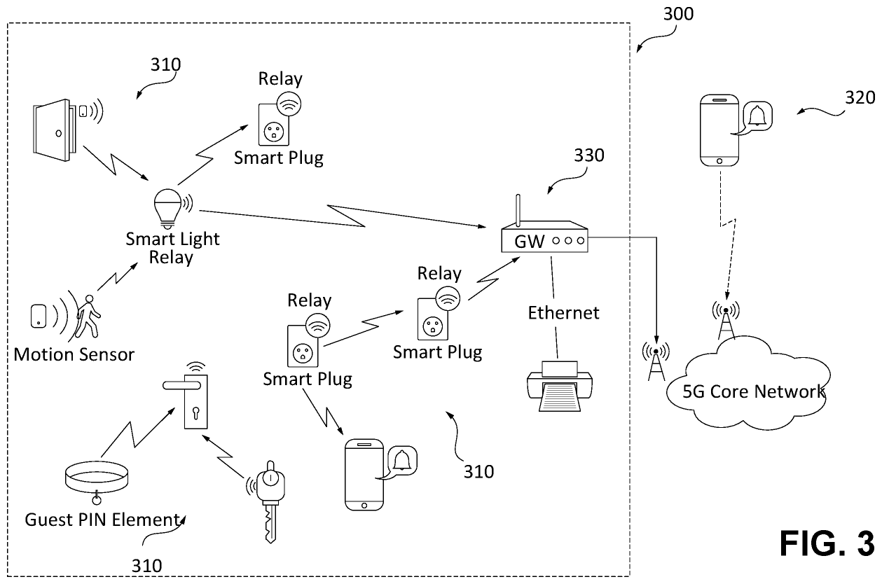

FIG. 3 is an example diagram of a Personal Internet of Things (IoT) Network (PIN) 300 in a home automation environment. When multiple IoT devices 310 (e.g., WTRUs with IoT capabilities) are deployed in a private environment, the WTRU(s) with IoT capabilities 310 may be organized in the Personal IoT Network (PIN) 300. For example, in home environment, motion sensor, smart light, smart plug, printer, cellphone, and the like, may be managed by a residential gateway and communicate with each other. One or more devices 310 in a home may constitute a PIN 300. Each of the devices 310 may be called a PIN element or PIN device. In one example, different PIN elements may have different capabilities. As an example, a residential gateway may be a PIN Element with Gateway Capability (PIN GW) 330 to provide connections between PIN elements and connections between 5G network and PIN Elements. A PIN Element with Management Capability (PIN Mgmt) may be a PIN Element that provides a means for an authorized administrator to configure and manage a PIN. As an example, a residential gateway which acts as a PIN GW 330 may support PIN management function and/or may also act as a PIN Mgmt. One or more PIN devices or PIN elements may be implemented in a WTRU. The terms PIN device, PIN element, WTRU, PIN client, and/or the like may be used interchangeably herein.

Wearable devices may also constitute another kind of PIN, in which a smart phone may act as a PEGC as well as a PEMC and smart watch, virtual reality/augmented reality (VR/AR) glass, airpods communicate with each other in the PIN (or with other WTRUs via the network).

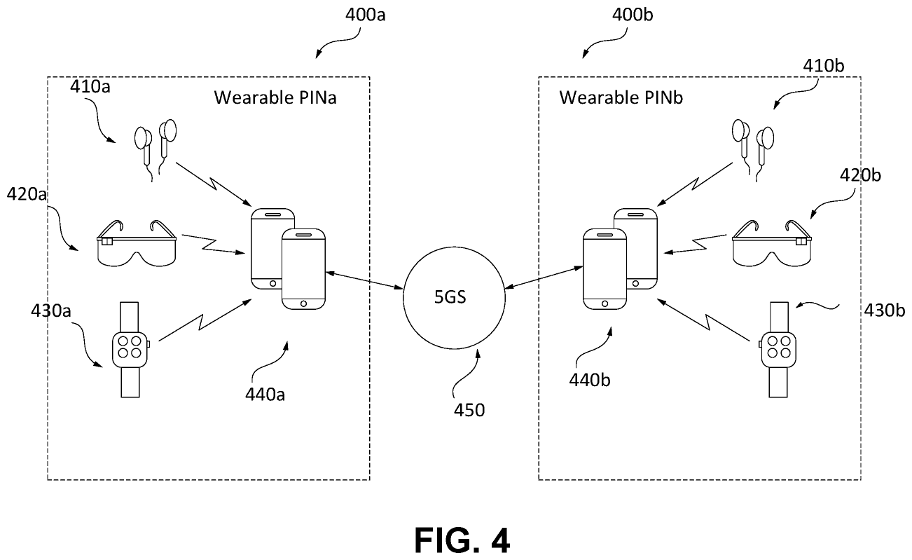

FIG. 4 is an example diagram of PINs 400a, 400b in wearable device environments. Wearable devices may constitute a type of PIN, for example, wearable PIN 400a or wearable PIN 400b. For example, a smart phone 440a, 440b may act as a PIN GW as well as a PIN Mgmt. A smart watch 430a or 430b, VR/AR glass 420a or 420b, and/or earphones 410a or 410b, may, for example, communicate with each other in the PIN 400a, 400b and/or with other WTRUs 440a, 440b via the 5G network 450.

A PIN application framework (PINAPP) may be provided for application layer support for PINs. PINAPP may include analyzing application layer architecture requirements of PIN, identifying key issues, and/or supporting PIN application layer functional model.

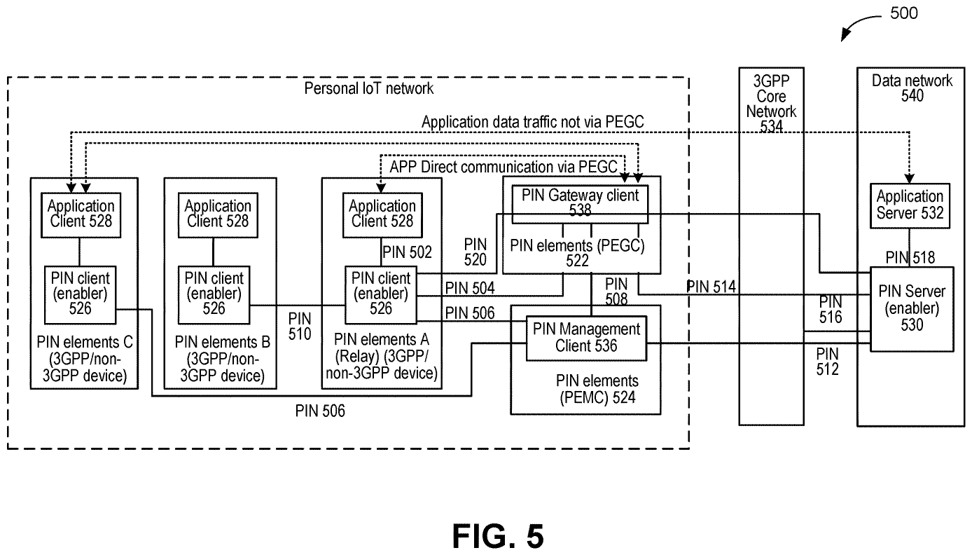

FIG. 5 is an example diagram of a PINAPP architecture 500. For example, FIG. 5 may illustrate the reference point representation of the architecture 500 for PINAPP. The application entities may be part of the PINAPP architecture 500 and enable the desired feature(s) in a PIN. The application entities may include a PIN client 526 in a PINE, a PIN gateway client 538 in a PEGC 522, a PIN management client 536 in a PEMC 524, and/or a PIN server 530 in a data network 540. Embodiments described herein may interchangeably use these functional entities and the PIN node, to enable one or more PINAPP features. The PIN elements may include a PIN client and/or an application client. The PIN Element with gateway capability (PEGC) 522 may perform the role of an entity supporting gateway capability for the PIN. The PIN Element with management capability (PEMC) 524 may perform the role of an entity supporting management capability for the PIN. A PIN may include at least one PEGC 522 and at least one PEMC 524.

A PIN enabler architecture (e.g., the PINAPP architecture 500) may include a PIN client deployed in a PIN element and a PIN server deployed in a Data network. The following interaction(s) may be supported in the PIN enabler architecture. The PIN client 526 may interact with the Application Client 528 on the PINE over PIN 502, for example, to provide and consume services in the PIN. The PIN server 530 may interact with Application Server(s) 532 over PIN 518. The PIN server 530 may interact with 3GPP networks 534 over PIN 516, for example, to consume 3GPP network services. The PIN management client(s) 536 may interact with PIN server 530 over PIN 512, for example, for services related to management of PIN. The PIN client(s) 526 may interact with PIN server 530 over PIN 520. One or more of these interactions may traverse via the PEGC 522. The PIN gateway client(s) 538 may interact with the PIN server 530 over PIN 514. The PIN client(s) 526 may interact with the PIN gateway client 538 over PIN 504. The PIN management client 536 may interact with the PIN gateway client(s) 538 over PIN 508. The PIN management client 536 may interact with one or more PIN client(s) 526 over PIN 506. The PIN client(s) 526 may interact with other PIN client(s) 526 over PIN 510.

A PEGC may establish a single or multiple protocol data unit (PDU) Sessions used for PIN communication. One PEGC may serve more than one PINs. One PIN may be served by one or more PDU sessions. A PIN may be served by more than one PDU session in the PEGC.

A PEGC may handle multiple PINs, have the same PDU session for traffic from multiple PINS, and/or its own application traffic.

When the PEGC is supporting multiple PINs with the same PDU session, the PEGC may handle deactivation and/or deletion of one PIN from the group of PINs which are being handled by PEGC to ensure that PINEs from the deactivated and/or deleted PIN are restricted to use the PDU session from the PEGC for data traffic. The PEGC may not use the PDU session to send traffic for the deleted and/or deactivated PIN. A PDU session may usually be released upon deletion of a PIN; but when the PDU session is being used by other PINs and/or by the PEGC for its own application traffic the PEGC may not release the PDU session. Described herein are methods and apparatuses that handle deactivation of one PIN in a multi-PIN scenario without releasing an entire PDU session.

A PIN may be a configured and managed group of PIN Elements which are able to communicate with each other directly or via a PEGC, communicate with the network via at least one PEGC, and be managed by at least one PEMC. A PINE may be a WTRU or a non-3GPP device that can communicate within a PIN (via PIN direct connection, via PEGC, or via PEGC and the core network), or outside the PIN via a PEGC and 5GC. PEGC may be a PIN Element with the ability to provide connectivity to and from the network for other PIN Elements, or to provide relay for the communication between PIN Elements. PEMC may be a PIN Element with capability to manage the PIN.

A PEGC may support multiple PINs simultaneously. For example, a PEGC may establish one or more PDU sessions for PIN communication. A PIN may be served by one or more PDU sessions. A PIN may be served by one or more PDU sessions in the PEGC. When a PEGC is supporting multiple PINs in the same PDU session, the PEGC may handle deactivation and/or deletion of Individual PIN ensure that UL traffic coming in from the PINEs associated with the deactivated and/or deleted PIN and DL traffic coming in to the core network (e.g., the SMF) for deactivated and/or deleted PIN is blocked/or not handled. Enhancement to route selection policies (e.g., URSP or PIN specific route selection policy (PRSP), introduction of new information element (PIN Session Status IE), which will be signaled over the control plane to synchronize deactivated and/or deleted PINs and new logic introduction at the WTRU level to ensure re-establishment of the PDU session at gateway level in case it was incorrectly released by the network, may be proposed.

The PEGC may support multiple PINs (e.g., PIN-1 and PIN-2) and PINEs from PIN-1 and PIN-2 use the PDU session established by the PEGC for the UL/DL data traffic to the external data network. When one of the connected PINs is deactivated and/or deleted, the PEGC may ensure that the PINEs from the deactivated and/or deleted PIN are restricted from using the PDU session for the UL/DL data traffic. The other use case may be when the network incorrectly releases the PDU session for the PEGC while it still has active PIN/PINEs connected to it. The trigger for the deactivation/deletion of a PIN may include one or more of validity expiry, user triggered, or AF (Application Function) for PIN could trigger deletion/deactivation of the PIN.

The WTRU may refer to PEGC or PEMC. PEMC and PEGC may be the same WTRU and can support multiple PINs.

A PDU session modification may be network-initiated. For example, the network may initiate modification of a multi-PIN PDU session. The network may deactivate a subset of (e.g., one or more) PINs associated with the multi-PIN PDU session. And, the network may inform the PEGC that the one or more PINs were deactivated so that the PEGC can block traffic from the one or more PINs associated with the multi-PIN PDU session. For example, the WTRU may block traffic from the one or more deactivated PINs and allow traffic from the active PINs.

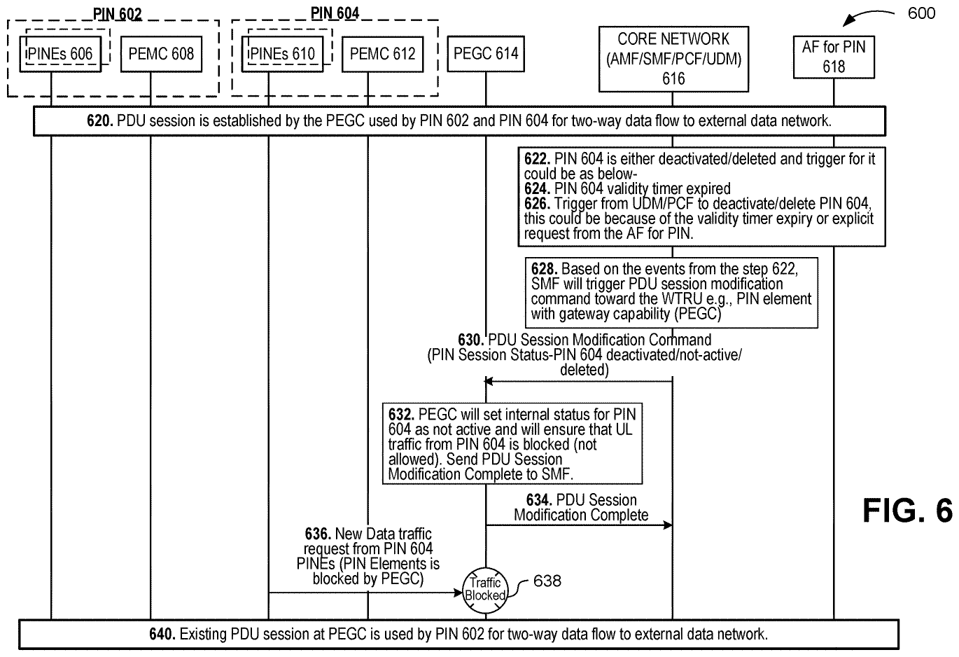

FIG. 6 depicts an example network-initiated PDU session modification procedure 600. The network-initiated PDU session modification procedure 600 may include multiple PINs 602, 604, a PEGC 614, a core network 616 (e.g., access and mobility function (AMF), session management function (SMF), policy control function (PCF) and/or user data management (UDM)), and/or an application function (AF) 618 for PIN. Each of the PINs 602, 604 may include one or more PINEs 606, 610 and one or more PEMCs 608, 612.

At 620, a PDU session (e.g., a multi-PIN PDU session) may be established by the PEGC 614. The connected PIN elements (PINEs 606 from PIN 602 and PINEs 610 from PIN 604) may be using the PDU session for uplink/downlink (UL/DL) data traffic to/from the external data network. For example, the PDU session may be a multi-PIN PDU session associated with sending and receiving data among the network 616, a first PIN 602, and a second PIN 604. PDU Session(s) that are used by the PINs 602, 604 may also be used by other (e.g., non-PIN related) applications.

At 622, the SMF 616 may be informed by UDM/PCF about the PIN deactivation/deletion. The trigger for the UDM or PCF may be the PIN validity timer expiry at 624, request from AF 618 for PIN. The SMF 616 may have a PIN validity timer. When the PIN validity timer expires, the SMF 616 may consider the PIN as deactivated and/or deleted. In more details, the PIN 604 may be either deactivated or deleted. For example, the PIN 604 may be partially deactivated. A partially deactivated PIN may be considered to be deactivated. The SMF 616 may receive a trigger from the UDM/PCF to deactivate or delete the PIN 604, on the request from AF 618 for PIN or validity timer expiry at UDM/PCF, as shown in 626.

At 628, the SMF 616 may trigger a PDU Session Modification procedure (e.g., by initiating a PDU Session Modification Command Message) to the PEGC 614 with a PIN session status information element (e.g., PIN Session Status IE (PIN 604 ID being set as deactivated and/or deleted)). In more details, based on events from 622, the SMF 616 may trigger PDU Session Modification procedure toward the PEGC 614. The SMF 616 may send, at 630, a NAS message to the PEGC 614. The NAS message may include a deactivation indication associated with PIN 604. For example, the NAS message may be a PDU Session Modification Command message with the PIN session status information element, for example, PIN Session Status IE, with PIN 604 ID marked as active, deactivated, deleted, or partially deactivated. Partially deactivated may mean a traffic for the PIN is partially allowed (for example, allowed for only IMS, rest is to be blocked). The deactivation indication may comprise the PIN Session Status IE. The PIN Session Status IE may comprise a minimum length of 4 octets and/or a maximum length of 34 octets.

At 632, the PEGC 614 may set internal status for PIN 604 as not active (e.g., deactivated) and may ensure that UL traffic (e.g., all UL traffic) from PIN 604 is blocked (e.g., not allowed). The PEGC 614 may send, at 634, a NAS message to the network that indicates that traffic from PIN 604 will be blocked for the multi-PIN PDU session. The second NAS message may be a PDU Session Modification Complete to the SMF 616 at 634. The PEGC 614 may send the second NAS message (e.g., PDU Session Modification Command message) to the network based on reception of the first NAS message (e.g., PDU session modification command message) from the network. The PEGC 614 may set the PIN 604 status as being active, deactivated, or deleted and respond back to the SMF 616 with the second NAS message (e.g., PDU Session Modification Complete message). The PEGC 614 may ensure that any UL traffic originating from PIN Elements 610 from the PIN 604 will be blocked. The PEGC 614 may inform PEMC 612 about the PIN 604 status as received from the network and may terminate connection with the PEMC 612 if required.

At 636, the PEGC 614 may receive data from PIN 604 in the multi-PIN PDU session. The PEGC 614 may determine to block the data received from PIN 604 (e.g., PIN Elements 610) based on the deactivation indication. The new data traffic from the PIN 604 PINEs 610 may be blocked at 638.

At 640, the PIN Elements 606 from the PIN 602 may still be able to use the multi-PIN PDU session from the PEGC 614 for UL/DL data traffic to the external data network. For example, the PEGC 614 may not block data from PIN 602 such that data from PIN 602 is able to use the multi-PIN PDU session.

In examples, the network may use a PIN Session Status information element (e.g., such as the PIN Session Status IE) to indicate PIN session status (e.g., if the PIN is active, deactivated, or deleted, and the like) to the WTRU (e.g., PEGC).

For example, the core network 616 (e.g., the AMF) may use the non-access stratum (NAS) signaling procedures (e.g., WTRU Configuration Update command, Notification message, DL NAS Transport procedure with either updated or new payload container type etc.) to inform the PEGC about the updated PIN Session Status IE, with PIN 604 ID marked as active, deactivated, deleted, or partially deactivated. Partially deactivated may mean a traffic for the PIN is partially allowed (for example, allowed for only IMS, rest is to be blocked). The WTRU may respond back with acknowledged PIN Session Status IE and complete the NAS signaling procedures.

The PIN session status information element may indicate the state of each PIN session that can be identified by a PIN identity. The PIN session status information element may be coded. The PIN session status information element may be a type 4 information element with minimum length of 4 octets and a maximum length of 34 octets. Table 1 and Table 2 depict an example PIN session status IE.

TABLE 1

| 8 | 7 | 6 | 5 | 4 | 3 | 2 | 1 | |
|---|---|---|---|---|---|---|---|---|
| PIN session status IEI | | | | | | | | octet 1 |
| Length of PIN session status contents | | | | | | | | octet 2 |
| PSI | PSI | PSI | PSI | PSI | PSI | PSI | PSI | octet 3 |
| (7) | (6) | (5) | (4) | (3) | (2) | (1) | (0) | |
| PSI | PSI | PSI | PSI | PSI | PSI | PSI | PSI | octet 4 |
| (15) | (14) | (13) | (12) | (11) | (10) | (9) | (8) | |
| 0 | 0 | 0 | 0 | 0 | 0 | 0 | 0 | octet 5*-34* |

spare

TABLE 2
PSI(x) shall be coded as follows:
PSI(0)-PSI(15):
0 indicates PIN SESSION INACTIVE.
1 indicates PIN SESSION ACTIVE
All bits in octet 5 to 34 are spare and shall be coded as zero,
if the respective octet is included in the information element.

A PDU session modification may be WTRU-initiated. For example, a WTRU may initiate modification of a multi-PIN PDU session. The WTRU may deactivate a subset of (e.g., one or more) PINs associated with the multi-PIN PDU session, for example, based on input via an application function over the user plane, user input, validity timer expiration, and/or other triggers. And, the WTRU may inform the network that the one or more PINs were deactivated so that the network can modify the multi-PIN PDU session accordingly. For example, the WTRU may block traffic from the one or more deactivated PINs and allow traffic from the active PINs.

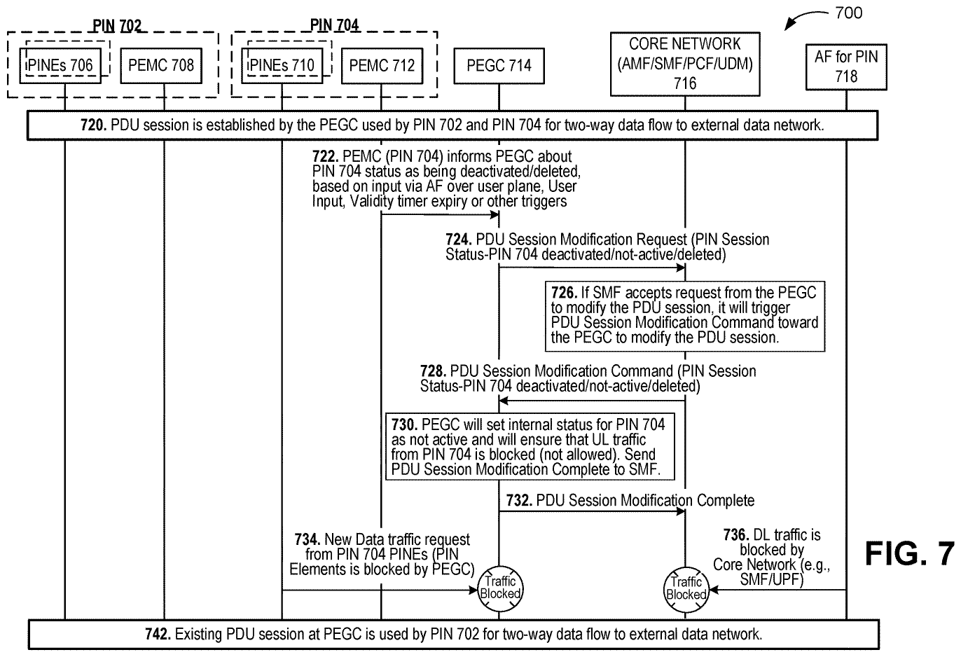

FIG. 7 depicts an example WTRU-initiated PDU session modification procedure 700. The WTRU-initiated PDU session modification procedure 700 may include multiple PINs 702, 704, a PEGC 714, a core network 716 (e.g., access and mobility function (AMF), session management function (SMF), policy control function (PCF) and/or user data management (UDM), and/or an application function (AF) 718 for PIN. Each of the PINs 702, 704 may include one or more PINEs 706, 710 and a PEMC 708, 712.

At 720, a PDU session (e.g., a multi-PIN PDU session) may be established by the PEGC 714. The PDU session may provide a data path between the PEGC 714 and the core network 716. The data path between the PEGC 714 and the core network 716 may be used to carry data from multiple PINs served by the PEGC 714. One or more connected PIN elements (e.g., PINEs 706 from PIN 702 and PINEs 710 from PIN 704) for UL/DL data traffic to the external data network. For example, the PDU session may be a multi-PIN PDU session associated with sending and receiving data among the network 716, a first PIN 702, and a second PIN 704. The PDU Session(s) that are used by the PINs 702, 704 may also be used by other (e.g., non-PIN related) applications.

At 722, a PEMC (e.g., PIN 704 PEMC 712) may inform the PEGC 714 about PIN 704 status as being deactivated and/or deleted (e.g., for the multi-PIN PDU session). The PEMC 712 may send a deactivation indication associated with the PIN 704 to the PEGC 714. For example, the PEMC 712 may indicate PIN 704 deactivation and/or deletion using AF 718 over user plane, user input, validity timer expiry, or other triggers. PEGC 714 may request PDU Session Modification Request from the network (e.g., the SMF 716) at 724, providing a PIN Session Status IE setting PIN 704 as active, deactivated, deleted, or partially deactivated. Partially deactivated may mean that traffic for the PIN is partially allowed (for example, allowed for only IMS, rest is to be blocked). For example, the PEGC 714 may send, at 724, a first NAS message (e.g., a PDU session modification request message) to the network 716. The NAS message may include a deactivation indication (e.g., such as the PIN Session Status IE).

At 726, the SMF 716 may accept a request from the PEGC 714 to modify the PDU session. The SMF 716 may trigger PDU Session Modification Command toward the PEGC 714 to modify the PDU session. At 728, the network 716 may send a second NAS message (e.g., a PDU session modification command message) to the PEGC 714. The second NAS message may include the deactivation indication. The SMF 716 may trigger the PDU Session Modification procedure, for example, by sending PDU Session Modification Command Message to the PEGC 714 at 728 along with the newly defined information element, for example, PIN Session Status IE with the PIN 704 ID marked as active, deactivated, deleted, or partially deactivated. Partially deactivated may mean a traffic for the PIN is partially allowed (for example, allowed for only IMS, rest is to be blocked). The PIN Session Status IE may be relayed back to the PEGC 714 to confirm that the status of PIN 704 (e.g., active, deactivated, deleted, or partially deactivated).

At 730, upon reception of the second NAS message (e.g., PDU session modification command message), the PEGC 714 may set the status for PIN 704 as active, deactivated, or deleted. For example, the PEGC 714 may set its internal status based on the deactivation indication (e.g., PIN Session status IE) in the second NAS message. The PEGC 714 may send a PDU Session Modification Complete message to the SMF 716 at 732. The PEGC 714 may ensure that any UL traffic originating from the PIN 704 PIN Element(s) 710 are blocked.

At 734, The PEGC 714 may receive data from PIN 704 (e.g., PINEs 710). The PEGC 714 may determine whether to allow the data to proceed to an external data network based on the internal status associated with PIN 704 and/or the deactivation indication in the second NAS message. For example, at 734, a new data traffic request from the PIN 704 PIN Element(s) 710 may be blocked by the PEGC 714. Any subsequent DL traffic may be blocked by the core network (e.g., SMF/UPF) at 736.

At 742, the PIN Elements 706 from PIN 702 may use the multi-PIN PDU session from PEGC for UL/DL data traffic to the external data network. For example, the PEGC 714 may not block data from PIN 702 such that data from PIN 702 is able to use the multi-PIN PDU session.

The PIN Session Status IE may be used by a WTRU to inform the network (e.g., SMF) about the PIN status (e.g., if the PIN is active, deactivated, or deleted, and the like.).

For example, the WTRU (for example, PEMC/PEGC) may trigger NAS signaling procedures (e.g., Mobility Registration Procedure, Service Request Procedure, UL NAS Transport procedure with either updated or new payload container type etc.) toward the network 716 (e.g., AMF) providing the updated PIN Session Status IE, for example, with PIN 704 ID marked as active, deactivated, deleted or partially deactivated. Partially deactivated may mean a traffic for the PIN is partially allowed (for example, allowed for only IMS, rest is to be blocked). The network 716 (e.g., AMF) may complete the procedure by sending respective NAS signaling messages back to the WTRU (e.g., Mobility Registration Update Accept, Service Accept etc.) and acknowledge the PIN Session Status (e.g., with PIN 704 ID marked as not active, deactivated, or deleted). The network 716 (e.g., AMF) may notify the SMF about the PIN Session Status IE. The SMF may modify the PDU Session Modification or release the PDU Session based on the received PIN Session status IE.

A PDU Session may be re-established when incorrectly released by the network. While a WTRU is camped normally on a cell (for example, normal or hosting network cell), the WTRU may trigger re-establishment of the PDU Session.

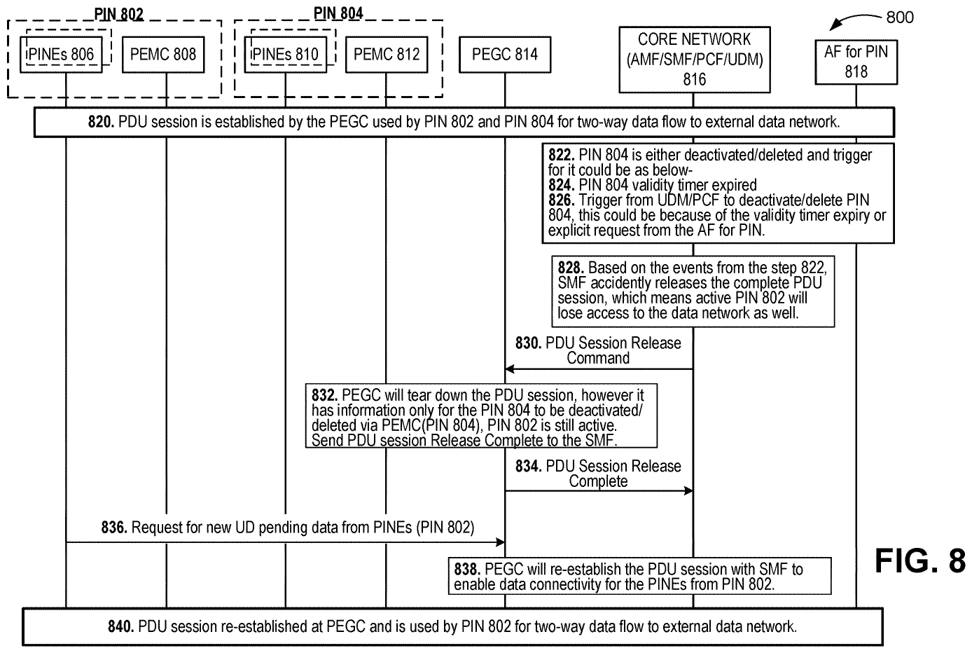

FIG. 8 depicts an example PDU session re-establishment procedure 800. The PDU session re-establishment procedure 800 may include multiple PINs 802, 804, a PEGC 814, a core network 816 (e.g., access and mobility function (AMF), session management function (SMF), policy control function (PCF) and/or user data management (UDM)), and/or an application function (AF) 818 for PIN. Each of the PINs 802, 804 may include one or more respective PINEs 806, 810 and a respective PEMC 808, 812.

At 820, a PDU session (e.g., a multi-PIN PDU session) may be established by the PEGC 814, which is being used by the connected PIN elements (PINEs 806 from PIN 802 and PINEs 810 from PIN 804) for UL/DL data traffic to the external data network. For example, the PDU session may be a multi-PIN PDU session associated with sending and receiving data among the network 816, a first PIN 802, and a second PIN 804. The PDU Session(s) that are used by the PINs 802, 804 may also be used by other (e.g., non-PIN related) applications.

At 822, the PIN 804 may be deactivated or deleted. The PIN 804 may be deactivated or deleted when a PIN 804 validity timer expires at the SMF level at 824. The PIN 804 may be deactivated or deleted based on a trigger from the UDM/PCF to deactivate/delete the PIN 804 at 826. The trigger from the UDM/PCF to deactivate/delete the PIN 802 may be based on a request from an AF for PIN or validity timer expiry at UDM/PCF.

At 828, The SMF 816 may release (e.g., accidently release) the PDU session. For example, the active PIN 802 may lose access to the data network (UL/DL data traffic), based on deactivation or deletion of the PIN 804. The SMF 816 may send a NAS message (e.g., a PDU Session Release Command) toward the PEGC (WTRU) 814 to release the ongoing PDU session at 830.

At 832, the PEGC 814 may tear down the PDU session. The PEGC 814 may have information for (e.g., only for) the PIN 804 to be deactivated and/or deleted via PEMC (e.g., the PIN 804 PEMC 812), The PIN 802 may still be active, and send a NAS message (e.g., a PDU Session Release Complete) to the SMF 816 at 834.

At 836, One or more PIN Elements 806 from PIN 802 may send a request for new UL pending data to the PEGC 814, as per the PEGC record that PIN 802 is still an active PIN.

At 838, the PEGC 814 may re-establish the PDU session with the SMF 816 to enable data connectivity for the PINEs 806 from PIN 802, as PIN 802 is still an active PIN and PDU session could have been incorrectly released by either network or loss of connectivity (e.g., out of service scenario).

At 840, the PDU session may be re-established at the PEGC 814, and may be used by the PIN elements 806 from PIN 802 for the UL/DL data traffic to the external data network.

PIN policy related procedures may be provided for a gateway WTRU (e.g., PEGC). For example, one or more WTRU policies may be updated at PIN deactivation/deletion. When the WTRU is camped normally on a cell (e.g., normal or hosting network cell), the WTRU may trigger updating the one or more WTRU policies.

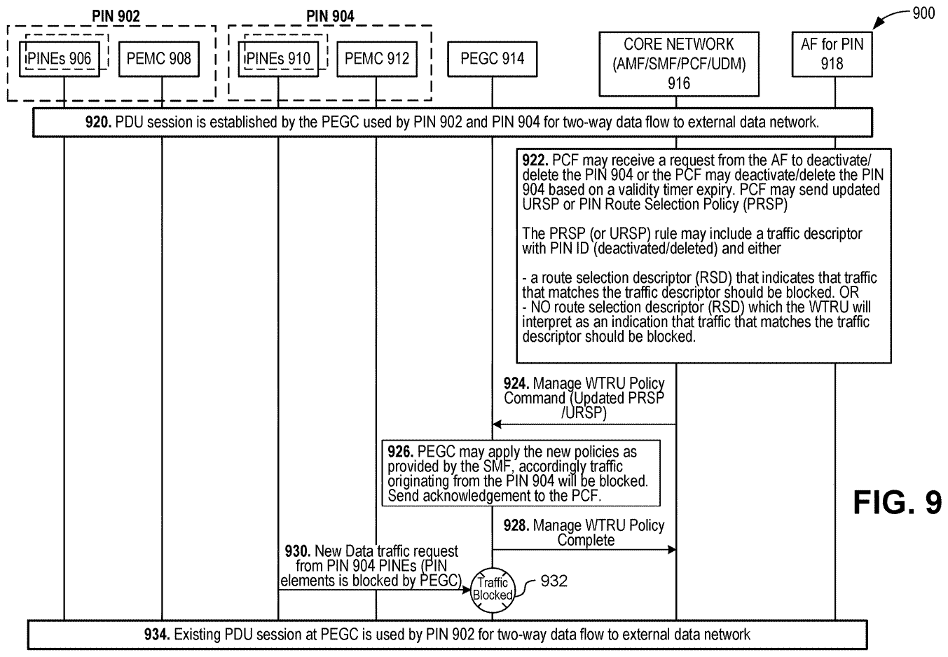

FIG. 9 depicts an example policy update procedure 900 at PIN deactivation/deletion. The policy update procedure 900 may include multiple PINs 902, 904, a PEGC 914, a core network 916 (e.g., access and mobility function (AMF), session management function (SMF), policy control function (PCF) and/or user data management (UDM)), and/or an application function (AF) 918 for PIN. Each of the PINs 902, 904 may include one or more respective PINEs 906, 910 and a respective PEMC 908, 912.

At 920, a multi-pin PDU session may be established by the PEGC 914, which is being used by the connected PIN elements (e.g., PINEs 906 from PIN 902 and PINEs 910 from PIN 904) for the UL/DL data traffic to/from the external data network.

At 922, the PCF 916 may receive a request from the AF 918 to deactivate, delete, or partially deactivate (e.g., selective blocking of the PIN traffic) the PIN 904. The request may be based on expiration of a validity timer. PCF 916 may send an updated URSP and/or PIN Route Selection Policy (PRSP). The PRSP (or URSP) rule may include a traffic descriptor with the PIN ID of the PIN 904 (deactivated, deleted, or partially deactivated). The PRSP (or URSP) rule may include the configuration. For example, the configuration may include a route selection descriptor (RSD) or a no RSD. The RSD may indicate that all or partial traffic (e.g., IMS traffic is allowed however internet is blocked) that matches the traffic descriptor should be blocked. The no RSD may indicate that traffic (e.g., all traffic) that matches the traffic descriptor should be blocked.

At 924, the PCF 916 may send a first NAS message (e.g., a manage WTRU Policy Command message) to the PEGC 914 via the AMF. The manage WTRU Policy Command message may include updated one or more URSP/PRSP rules.

Additionally or alternatively, the network 916 (e.g., AMF) may trigger one or more other NAS signaling procedures (e.g., WTRU Configuration Update command, Notification message, DL NAS Transport procedure with either updated or new payload container type, Updated WTRU Policy Container, WTRU parameters update transparent container, N1 SM information, etc.) toward the PEGC 914 providing the updated PRSP (or URSP). The Updated WTRU Policy Container may be a WTRU Policy Container and the WTRU parameters update transparent container may be a WTRU parameters update transparent container. The WTRU may respond back with acknowledging and completing the one or more NAS signaling procedures.

At 926, the PEGC 914 may apply the new policies as provided by the PCF 916. Accordingly, traffic originating from the PIN 904 may be blocked. The PEGC 914 may send acknowledgement (e.g., a Manage WTRU Policy Complete Message) to the PCF 916 at 928. For example, the PEGC 914 may send a second NAS message (e.g., the manage WTRU policy complete message) to the network 916.

At 930, the PEGC 914 may block new data traffic request(s) from the PIN 904 PIN Elements 910. The new data traffic from the PIN 904 PINEs 910 may be blocked at 932.

At 934, the PIN elements 906 from the PIN 902 may use the PDU session from the PEGC 914 for the UL/DL data traffic to the external data network.

The new WTRU policies may be defined, for example, URSP or PRSP (PIN Route Selection Policy), which may be configured such that a gateway WTRU will block traffic matching the provided traffic descriptors in these policies.

What is claimed is:

1. A wireless transmit/receive unit (WTRU) comprising one or more processors configured to:
establish a multi-personal internet of things (IoT) network (PIN) protocol data unit (PDU) session associated with sending and receiving data among an external network and a first PIN and a second PIN;
receive a first non-access stratum (NAS) message from the external network, the first NAS message comprising a deactivation indication associated with the second PIN;
receive data from the second PIN in the multi-PIN PDU session;
determine to block the data received from the second PIN in the multi-PIN PDU session based on the deactivation indication; and
send a second NAS message to the external network that indicates that the traffic from the second PIN will be blocked for the multi-PIN PDU session.

2. The WTRU of claim 1, wherein the first NAS message is a PDU session modification command message and the second NAS message is a PDU session modification complete message.

3. The WTRU of claim 2, wherein the deactivation indication associated with the second PIN comprises a PIN session status information element, and wherein the PIN session status information element is configured to indicate whether a respective PIN is activated, partially deactivated, deactivated, or deleted.

4. The WTRU of claim 3, wherein the PIN session status information element comprises a minimal length of 4 octets and a maximum length of 34 octets.

5. The WTRU of claim 2, wherein the WTRU is further configured to set an internal status for the second PIN to deactivated based on the PDU session modification message.

6. The WTRU of claim 2, wherein the deactivation indication associated with the second PIN indicates that the second PIN is at least partially deactivated.

7. The WTRU of claim 2, wherein the deactivation indication associated with the second PIN comprises a deactivation indication only associated with the second PIN.

8. The WTRU of claim 2, wherein the WTRU is further configured to send a PDU session modification request message to the external network, wherein the PDU session modification request message comprises the deactivation indication associated with the second PIN, and wherein the PDU session modification command message is received in response to the PDU session modification request message.

9. The WTRU of claim 1, wherein the first NAS message is a policy command message that comprises one or more of updated user equipment route selection policy (URSP) rules, wherein the one or more of the updated URSP rules comprise a traffic descriptor, wherein the traffic descriptor is associated with the second PIN, and wherein the traffic descriptor comprises an indication to block traffic that matches the traffic descriptor.

10. The WTRU of claim 1, wherein the WTRU is further configured to:
receive data from the first PIN; and
determine to allow the data received from the first PIN to use an uplink/downlink (UL/DL) data traffic to the external network based on the first NAS message.

11. A method comprising:
establishing a multi-personal internet of things (IoT) network (PIN) protocol data unit (PDU) session associated with sending and receiving data among an external network and a first PIN and a second PIN;
receiving a first non-access stratum (NAS) message from the external network, the first NAS message comprising a deactivation indication associated with the second PIN;
receiving data from the second PIN in the multi-PIN PDU session;
determining to block the data received from the second PIN in the multi-PIN PDU session based on the deactivation indication; and
sending a second NAS message to the external network that indicates that the traffic from the second PIN will be blocked for the multi-PIN PDU session.

12. The method of claim 11, wherein the first NAS message is a PDU session modification command message and the second NAS message is a PDU session modification complete message.

13. The method of claim 12, wherein the deactivation indication associated with the second PIN comprises a PIN session status information element, and wherein the PIN session status information element is configured to indicate whether a respective PIN is activated, partially deactivated, deactivated, or deleted.

14. The method of claim 13, wherein the PIN session status information element comprises a minimal length of 4 octets and a maximum length of 34 octets.

15. The method of claim 12, further comprising:
setting an internal status for the second PIN to deactivated based on the PDU session modification message.

16. The method of claim 12, wherein the deactivation indication associated with the second PIN indicates that the second PIN is at least partially deactivated.

17. The method of claim 12, wherein the deactivation indication associated with the second PIN comprises a deactivation indication only associated with the second PIN.

18. The method of claim 12, further comprising:
sending a PDU session modification request message to the external network, wherein the PDU session modification request message comprises the deactivation indication associated with the second PIN, and wherein the PDU session modification command message is received in response to the PDU session modification request message.

19. The method of claim 11, wherein the first NAS message is a policy command message that comprises one or more of updated user equipment route selection policy (URSP) rules, wherein the one or more of the updated URSP rules comprise a traffic descriptor, wherein the traffic descriptor is associated with the second PIN, and wherein the traffic descriptor comprises an indication to block traffic that matches the traffic descriptor.

20. The method of claim 11, further comprising:
receiving data from the first PIN; and
determining to allow the data received from the first PIN to use an uplink/downlink (UL/DL) data traffic to the external network based on the first NAS message.
